(19) United States
(12) Patent Application Publication
(10) Pub. No.: US 2010/0152875 A1
(43) Pub. Date: Jun. 17, 2010

(54) ESTIMATION APPARATUS AND ESTIMATION METHOD

(75) Inventor: Daisuke Fukuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/632,258

(22) Filed: Dec. 7, 2009

(30) Foreign Application Priority Data
Dec. 11, 2008 (JP) 2008-316175

(51) Int. Cl. G06F 17/50

(52) U.S. Cl. 700/104; 700/121

(57) ABSTRACT

An estimation apparatus for estimating a formation of a plurality of wiring layers for an integrated circuit to be manufactured by laminating the wiring layers each formed through a deposition process of a wiring material on a substrate and subsequently polishing the deposited wiring material, the apparatus includes a deposition estimator, a polishing estimator, and an adjuster. The apparatus includes an optimizer configured to optimize distribution of the height of the wiring material for each of the wiring layers within an acceptable range by controlling the adjuster to generate various combinations of adjusted patterns of the wiring layers and by controlling the deposition estimator and the polishing estimator to perform estimation of distribution of deposition height of the wiring material and distribution of the wiring material to be remained after polishing for each of the wiring layers, respectively, for each of the combinations of the adjusted patterns.

### CROSS-REFERENCE TO RELATED APPLICATION

This application is based upon and claims the benefit of priority of the prior Japanese Patent Application No. 2008-316175, filed on Dec. 11, 2008, the entire contents of which are incorporated herein by reference.

### FIELD

The embodiments discussed herein are related to an estimation technique for estimating a formation of a plurality of wiring layers for an integrated circuit.

### BACKGROUND

In a manufacturing process of a semiconductor integrated circuit, light exposure, etching, deposition (plating) and polishing are repeated on a wafer to construct a laminate structure, thereby forming a desired circuit. At this time, productivity is enhanced by simultaneously forming plural semiconductor integrated circuits on one wafer.

Particularly, it has been recently needed to increase the wafer diameter and thus increase the number of circuits to be formed in a lump. However, as the large-size design of the wafer progresses, it is harder to execute uniform processing on both the center portion and the peripheral portion of a wafer. In addition, miniaturization of circuits also progresses, and thus high-precision processing has been needed.

For example, with respect to recently mainstream copper wires, ECP (Electro-Chemical Plating) of generating a wire groove on an insulating material and executing copper plating on the wire groove to fill the wire groove with copper is executed. However, not only the wire groove, but also the overall insulating material is covered by copper plating at the same time, and thus CMP (Chemical Mechanical Polishing) is used as polishing for exposing a wire pattern.

Here, when a large height difference exists on the wafer as a result of CMP, dispersion in height of copper wires or wiring short-circuiting caused by residue of copper occurs. In each case, deterioration of performance or reduction in yield occurs.

Furthermore, there is a case where a problem occurs in case of a lamination layer although no problem occurs in case of a monolayer. Particularly, such a problem is liable to occur in a case where a lower layer is positionally lower than the surrounding and an upper layer is positionally higher than the surrounding.

It has been hitherto general to actually manufacture a semiconductor integrated circuit and correct the layout thereof after an error occurs in the thus-manufactured semiconductor integrated circuit. This process is very low in efficiency from the viewpoint of the manufacturing cost and the time cost because a wafer is actually created. Therefore, a method of simulating CMP and perform prediction and correction before the actual manufacturing has been proposed. There is Japanese Laid-open Patent Publication No. 2003-224098 as a reference document.

However, when a chip is actually created and then corrected, the manufacturing cost and the time cost are caused to increase. Furthermore, when chips are manufactured with containing risky portions therein, the yield is reduced by about ten percentages.

When the CMP simulation is used, it is unnecessary to actually manufacture chips. Therefore, it contributes to some degree of reduction in cost. However, the simulation needs several hours to about one day in accordance with the size of chips. When a risk portion is corrected, the CMP simulation is needed to be executed many times, and thus the total simulation time is equal to several days to several weeks in some cases.

That is, the conventional technique has a problem that much time is taken to obtain a CMP result, and thus huge amounts of time are needed to determine an optimum circuit layout.

### SUMMARY

According to an aspect of the embodiment an estimation apparatus for estimating a formation of a plurality of wiring layers for an integrated circuit to be manufactured by laminating the wiring layers each formed through a deposition process of a wiring material on a substrate and subsequently polishing the deposited wiring material, the apparatus includes a deposition estimator configured to estimate distribution of a deposition height of the wiring material for each of the wiring layers, a polishing estimator configured to estimate distribution of a height of the wiring material to be remained after polishing for each of the wiring layers on the basis of the estimated distribution of the deposition height of the wiring material of each of the wiring layers and the estimated distribution of the height of the wiring material to be remained after polishing for any underlying wiring layer, an adjuster configured to adjust the pattern of at least one of the wiring layers without affecting the electrical function of the at least one of the wiring layers, and an optimizer configured to optimize distribution of the height of the wiring material for each of the wiring layers within an acceptable range by controlling the adjuster to generate various combinations of adjusted patterns of the wiring layers and by controlling the deposition estimator and the polishing estimator to perform estimation of distribution of deposition height of the wiring material and distribution of the wiring material to be remained after polishing for each of the wiring layers, respectively, for each of the combinations of the adjusted patterns.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the construction of an LSI manufacturing system according to an embodiment.

FIG. 2 is a diagram illustrating CMP estimation and a risk degree.

FIGS. 3A, 3B and 3C are diagrams illustrating a scrape amount of CMP.

FIG. 4 is a diagram illustrating risk degree estimation based on ECP.

FIGS. 5A and 5B are diagrams illustrating risk estimation executed in consideration of a lamination layer.

FIG. 6 is a diagram illustrating creation of maximum risk degree data.

FIG. 7 is a flowchart illustrating the processing operation of an LSI manufacturing system.

FIG. 8 is a flowchart illustrating the processing operation based on a mesh divider 21, an ECP calculator 22 and a risk degree estimator 23.

FIG. 9 is a flowchart illustrating the processing operation of an each-mesh maximum risk degree extractor 24, each-layer adjustment range calculator 25, an optimizing processor 26 and a dummy metal arranging unit 27.

FIG. 10 is a diagram illustrating calculation of a risk degree and an adjustment range.

FIG. 11 is a diagram illustrating a specific example of each-layer mesh data.

FIG. 12 is a diagram illustrating creation of a deposition height ecp (nm) and a monolayer risk degree F1.

FIG. 13 is a diagram illustrating a specific example of maximum risk degree data.

FIG. 14 is a diagram illustrating a specific example of corrected candidate mesh data.

FIG. 15 is a diagram illustrating each-layer mesh data representing a risk degree adjustment range of each layer.

FIG. 16 is a diagram illustrating each-layer mesh data representing an optimum monolayer risk degree F2 of each layer.

FIG. 17 is a diagram illustrating a dummy copper density Bdens in the optimum monolayer risk degree F2 and each-layer mesh data representing a dummy wire circumferential length Bedge.

FIG. 18 is a diagram illustrating each-layer mesh data obtained by updating the dummy-based copper density Ddens (%), the dummy-based wire circumferential length Dedge (nm), the deposition height ecp (nm) and the monolayer risk degree F1.

### DESCRIPTION OF EMBODIMENTS

Embodiments of an estimation apparatus, an estimation method and an estimation program will be described hereunder in detail with reference to the drawings.

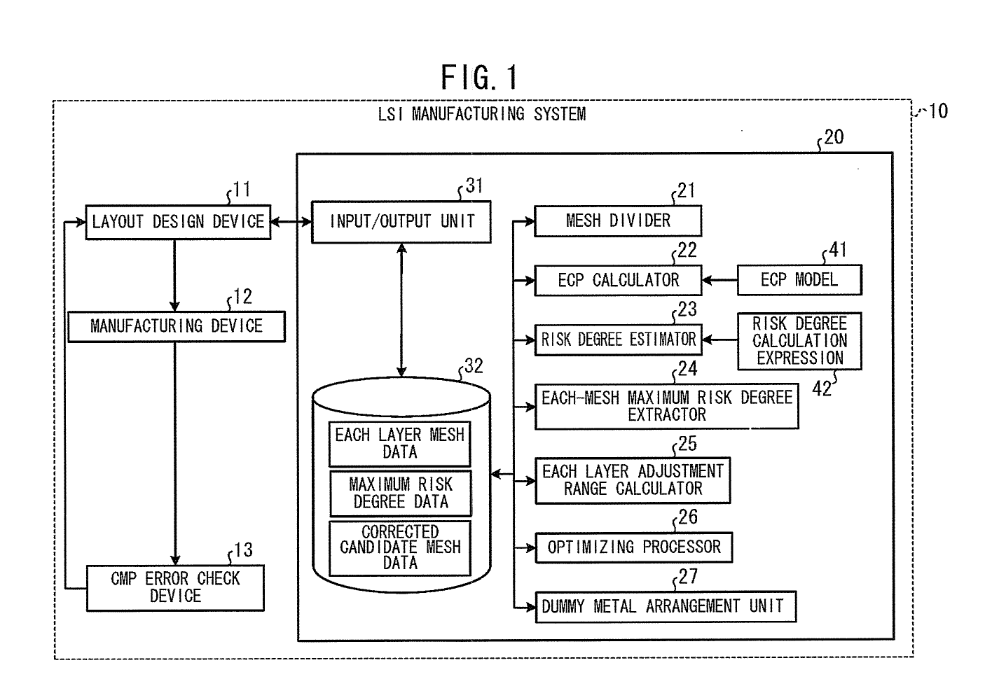

FIG. 1 is a diagram illustrating the construction of an LSI (large-scale integrated circuit) manufacturing system according to an embodiment. As illustrated in FIG. 1, the LSI manufacturing system 10 includes a layout design device 11, a manufacturing device 12, a CMP error check device 13 and an estimation apparatus 20.

The layout design device 11 is a device for designing a circuit layout of LSI, and first outputs a designed circuit layout to the estimation device 20. The estimation device 20 predicts and estimates an execution result of CMP from the circuit layout, and returns an estimation result to the layout design device 11.

When the estimation result of the estimation apparatus 20 is insufficient, the layout design device 11 corrects the layout, and outputs the corrected layout to the estimation apparatus 20. The circuit layout whose prediction and estimation result is excellent is output to the manufacturing device 12.

The manufacturing device 12 manufactures LSI on the basis of the circuit layout obtained from the layout design device 11. In this case, the manufacturing device 12 estimates the state after execution of actual polishing by a CMP error check device 13 every layer (one cycle of exposure, etching, deposition (plating) and polishing), and returns the estimation result to the layout design device 11.

The layout design device 11 reflects the estimation result of the CMP error check device 13 to the circuit layout, determines a final layout and delivers the final layout to a mass production line, for example.

The estimation apparatus 20 includes an input/output potion 31, a data base 32, a mesh divider 21, an ECP calculator 22 for a deposition estimator, a risk degree estimator 23 for a polishing estimator, an each-mesh maximum risk degree extractor 24, an each-layer adjustment range calculator 25, an optimizing processor 26 and a dummy metal arranging unit 27.

The input/output processor 31 is an interface for registering the circuit layout received from the layout design device 11 into the data base 32, reading out the data updated/created through the processing in the estimation apparatus 20 and delivering the updated/created data to the layout design device 11.

The mesh divider 21 subjects the circuit layout registered in the data base 32 to mesh division. Here, the circuit layout corresponds to a laminate of plural wiring layers (monolayer circuit layouts) each of which is formed through one cycle of exposure, etching, deposition (plating) and polishing described above. The mesh divider 21 divides each of the plural wiring layers into meshes as partial areas, and registers them in the data base as mesh data of each layer (each-layer mesh data). When the mesh divider 21 divides the plural wiring layers, the division is performed so that the position and size of the meshes are identical among the respective wiring layers, and also the meshes are overlapped with each other between the upper and lower layers when the upper and lower layers are laminated.

The ECP calculator 22 uses an ECP model 41 to calculate the deposition height after ECP is executed on each divisional mesh. A model for calculating a deposition height on the basis of a wire density and a wire circumferential length is known as the ECP model for calculating the deposition height after execution of ECP.

The risk degree estimator 23 compares a prediction value of the deposition height of a mesh with prediction values of the deposition heights of surrounding meshes by using a risk degree calculation expression 42 to calculate an estimation value for the CMP process, and determines the risk degree of CMP from the calculation result.

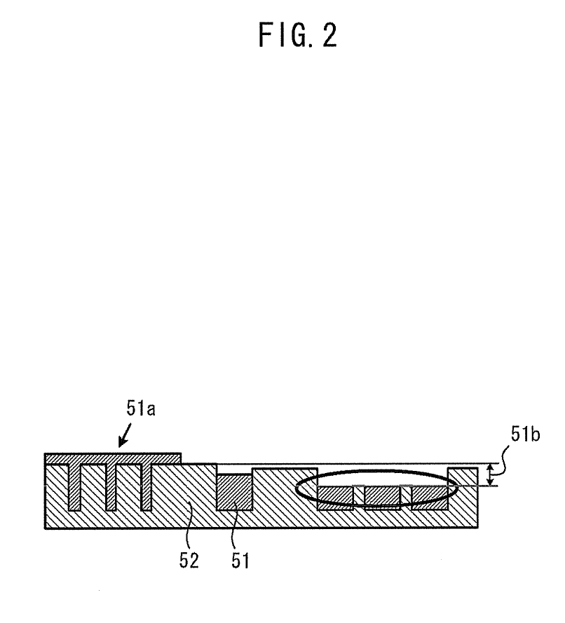

The CMP estimation and the risk degree will be further described with reference to FIG. 2. In FIG. 2, unevenness occurs on the surface as a result of CMP. A convex portion 51a occurs because wiring materials (for example, copper) deposited (plated) by ECP remains. The convex portion 51a remaining on oxide 52 (for example, silicon oxide) for insulating copper wires 51 from each other causes wire short-circuit. Furthermore, a concave portion 51b occurs because copper deposited (plated) by ECP is excessively scraped. The wire resistance of the concave portion 51b increases, and causes deterioration of the circuit performance.

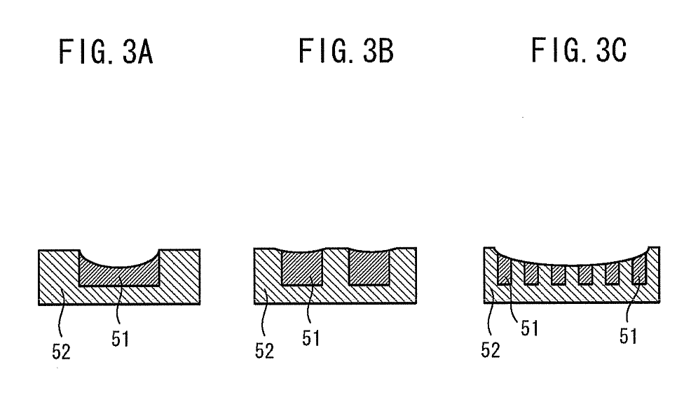

The scrape amount based on CMP varies in accordance with not only the wire density, but also the wire width. Even when the wire density is equal to 50%, the wire portion would be greatly scraped if the wire width is large as illustrated in FIG. 3A. This happens because copper is more easily scraped than oxide. Even when the wire density is equal to 50% and the wire width is small as illustrated in FIG. 3C, the wire portion is more easily scraped as a whole because the width of the oxide is also reduced. On the other hand, when the wire density is equal to 50% and the wire width is middle as illustrated in FIG. 3B, the width of the oxide is sufficiently stout to CMP and also the oxide portions are arranged at proper intervals, so that the scrape amount is small.

Therefore, by utilizing the fact that the height of ECP (plating) or the deposition amount of copper propagates and it affects the height after polishing based on CMP, the estimation apparatus 20 obtains the height difference between the deposition height of copper and the height of the surrounding portion as an estimation value, that is, it estimates the result of CMP and obtains it as a value representing a risk degree at which wiring short-circuiting or deterioration of circuit performance occurs.

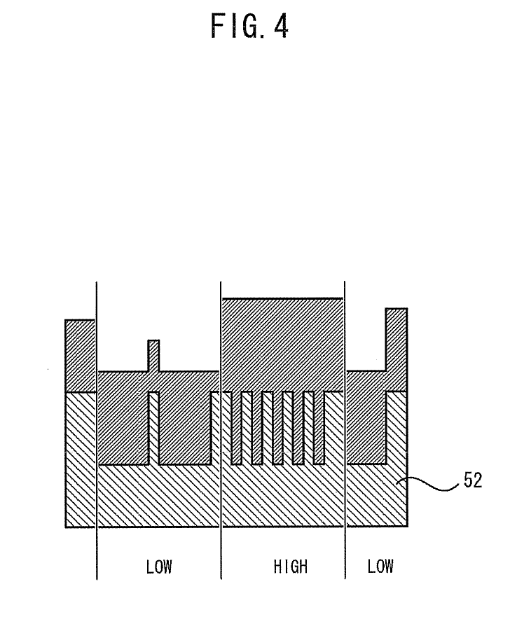

Specifically, when a target place is high and the surrounding portion around the target place is low as illustrated in FIG. 4, it is determined that the risk degree is high. When the deposition height of the target place is high and the surrounding portion is also high, it is determined that the risk degree is low, and also when the deposition height of the target place is low and the surrounding portion is also low, it is likewise determined that the risk degree is low.

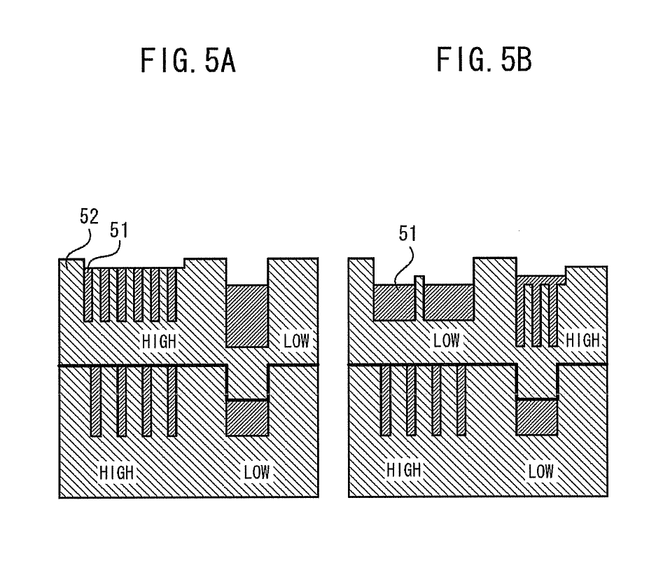

Furthermore, in consideration of the fact that the unevenness after CMP is amplified by the lamination, the height difference between the upper and lower layers is also estimated. For example, as illustrated in FIG. 5B, in a case where the lower layer is low and the upper layer is high, copper is more liable to remain at a portion where copper is originally liable to remain because the bottom surface of the portion concerned is lower than the surrounding portion around the portion concerned. Therefore, a trouble caused by wire short-circuit may occur at this portion.

In a case where the lower layer is high and the upper layer is low, copper is more easily scraped at a portion where copper is originally easily scraped because the bottom surface of the portion concerned is higher than the surrounding portion around the portion concerned. Therefore, the wire height is reduced, and thus the deterioration of performance may occur.

On the other hand, as illustrated in FIG. 5A, in a case where both the lower layer and the upper layer are high and also in a case where both the lower layer and the upper layer are low, the wiring short-circuiting and the deterioration performance relatively hardly occur. Therefore, in the estimation apparatus 20, the estimation value of the mesh is compared with the estimation values of the upper and lower layers, whereby a lamination-layer estimation value is calculated in consideration of the lamination layer.

The each-mesh maximum risk degree extractor 24 creates maximum risk degree data obtained by extracting the maximum risk degree as the maximum estimation value representing highest necessity of improvement from estimation values of plural meshes laminated at the same position on a deposition plane.

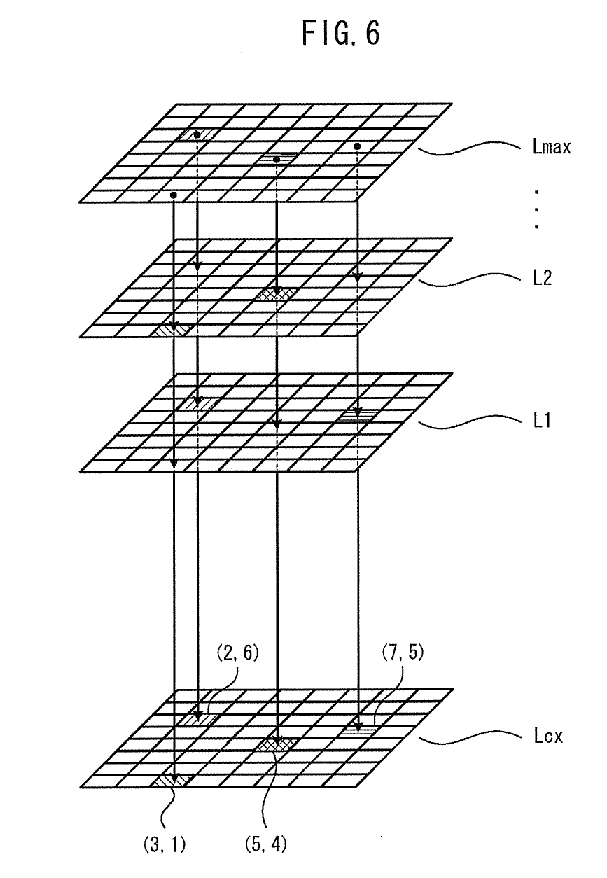

The creation of the maximum risk degree data will be described with reference to FIG. 6. When the risk degrees of meshes at the coordinate (x,y)=(3,1) are compared with one another, the risk degree on a second layer (layer L2) is highest, and thus the maximum risk degree of the mesh (3, 1) of the maximum risk degree data Lcx is set to the same value as the risk degree of the mesh (3, 1) of the layer L2.

Likewise, when the risk degrees of the meshes at the coordinate (x,y)=(5, 4) are compared with one another, the risk degree on the second layer (layer L2) is highest, and thus the maximum risk degree of the mesh (5, 4) of the maximum risk degree data Lcx is set to the same value as the risk degree of the mesh (5, 4) of the layer L2.

Furthermore, when the risk degrees of the meshes at the coordinate (x,y)=(7, 5) are compared with one another, the risk degree of a layer (layer L1) which is first formed on the deposition plane is highest, and thus the maximum risk degree of the mesh (7, 5) of the maximum risk degree data Lcx is set to the same value as the risk degree of the mesh (7, 5) of the layer L2.

When the risk degrees of the meshes at the coordinate (x,y)=(2, 6) are compared with one another, the risk degree of a layer (layer Lmax) which is finally formed on the deposition plane is highest, and thus the maximum risk degree of the mesh (2, 6) of the maximum risk degree data Lcx is set to the same value as the mesh (2, 6) of the layer Lmax.

The each-layer adjustment range calculator 25 registers mesh coordinates providing the maximum risk degrees exceeding a threshold value in the maximum risk degree data into the corrected candidate mesh data.

With respect to each of the mesh coordinates registered in the corrected candidate mesh data, the each-layer adjustment range calculator 25 calculates a risk-degree changeable range of each of the meshes of the respective layers to be laminated on the mesh coordinate concerned. Here, a case where the adjustment range of the risk degree is determined will be described. The risk degree is a value determined on the basis of the deposition height, and thus the adjustment range of the deposition height may be determined.

Specifically, the adjustment of the risk degree or the deposition height is executed by changing the layout (patterns) of dummy metal as a wire which does not affect the electrical characteristic of the circuit.

The optimizing processor 26 optimizes the distribution of the risk degree (or the deposition height when the deposition height is used) of each mesh in the adjustment range calculated by the each-layer adjustment range calculator 25.

The dummy metal arranging unit 27 calculates the arrangement of the dummy metal of each mesh so that the mesh concerned has the risk degree (or the deposition height when the deposition height is used) calculated by the optimizing processor 26.

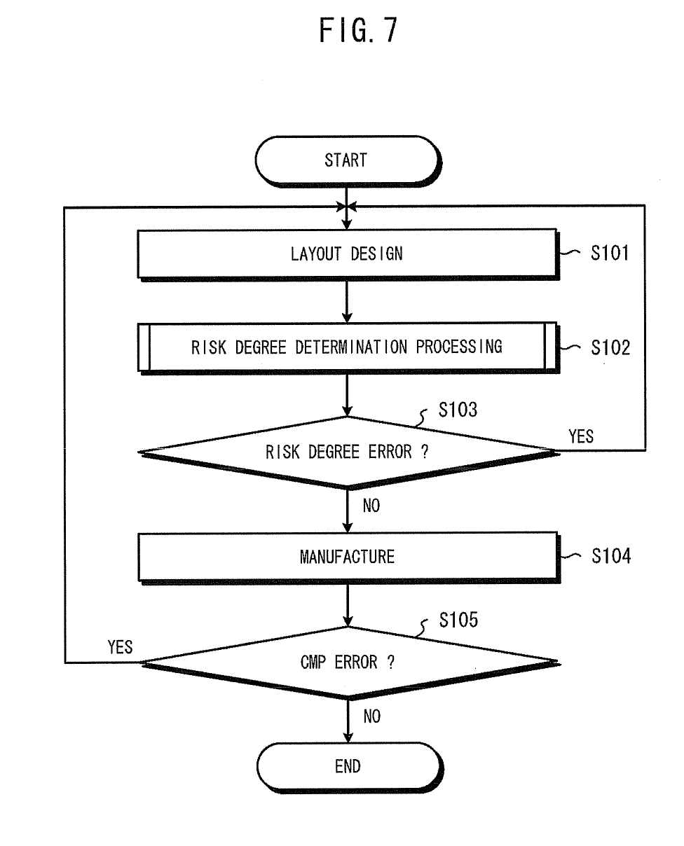

Next, the overall processing operation of the LSI manufacturing system will be described with reference to the flowchart of FIG. 7. As illustrated in FIG. 7, the layout design device 11 first designs a layout (operation S101), and then the estimation apparatus 20 executes risk degree determination processing (operation S102).

As a result, when a risk degree which is not less than a threshold value is output, the estimation apparatus 20 outputs a risk degree error (operation S103, Yes), and the layout design device 11 which receives the risk degree error executes layout design again (operation S101).

On the other hand, when the risk degree is less than the threshold value (operation S103, No), the manufacturing device 12 executes the manufacturing (operation S104), and the CMP error check device 13 executes the CMP error check (operation S105).

As a result, when the CMP error check device 13 outputs the CMP error (operation S105, Yes), the layout design device 11 executes the layout design again (operation S101). When the CMP error check device 13 does not output any CMP error (operation 5105, No), it is determined that a proper circuit layout is obtained, and thus the processing is finished.

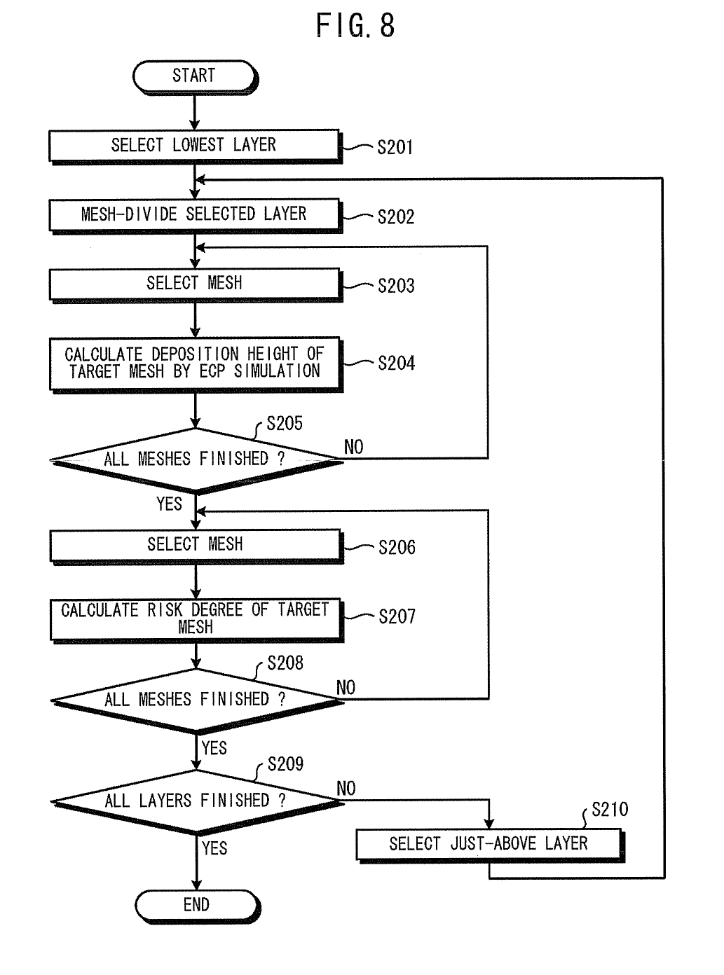

Next, a specific processing operation of the risk degree determination processing of the estimation apparatus 20 will be described. FIG. 8 is a flowchart illustrating the processing operation based on the mesh divider 21, the ECP calculator 22 and the risk degree estimator 23.

The mesh divider 21 first selects the lowermost layer, that is, a circuit layout to be first formed on the deposition plane from the each-layer mesh data (operation S201), and subjects the selected layer to mesh division (i.e., divides the selected layer into plural meshed areas) (operation S202).

Subsequently, the ECP calculator 22 selects a mesh as a processing target (operation S203), and calculates the deposition height of the target mesh by ECP simulation (operation S204).

Thereafter, the ECP calculator 22 determines whether the calculation of the deposition height on all the meshes is finished or not (operation S205). If the calculation is not finished (operation S205, No), the processing returns to the mesh selection (operation S203).

When the calculation of the deposition height on all the meshes is finished (operation S205, Yes), the risk degree estimator 23 selects a next processing target mesh (operation S206), and executes the risk degree calculation on the target mesh concerned (operation S207).

Thereafter, the risk degree estimator 23 determines whether the risk degree calculation on all the meshes is finished or not (operation S208). If the calculation is not finished (operation S208, No), the processing returns to the mesh selection (operation S206).

When the calculation of the risk degree on all the meshes is finished (operation S208, Yes), it is determined whether the processing on all the layers is finished or not (operation S209). When the processing is not finished (operation S209, No), the processing returns to the selection of the determination target layer, and a just-above layer is selected (operation S201).

When the determination on all the layers is finished (operation S209, Yes), a calculation result is output (operation S210), and the processing is finished.

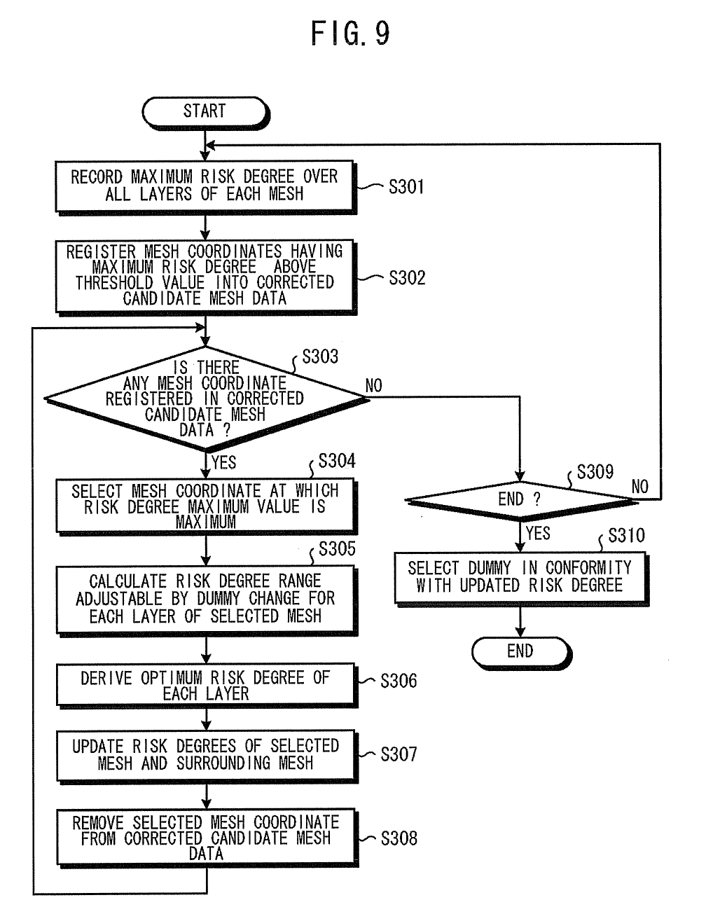

FIG. 9 is a flowchart illustrating the processing operation of the each-mesh maximum risk degree extractor 24, the each-layer adjustment range calculator 25, the optimizing processor 26 and the dummy metal arranging unit 27.

First, the each-mesh maximum risk degree extractor 24 records, as the maximum risk degree, the maximum value of the risk degrees of all the meshes to be laminated on each mesh coordinate in association with the mesh coordinate (operation S301). Furthermore, it registers, in the corrected candidate mesh data, mesh coordinates at which the maximum risk degrees are not less than a threshold value (operation S302).

When there exists some mesh coordinate registered in the corrected candidate mesh data (operation S303, Yes), the each-layer adjustment range calculator 25 selects the mesh coordinate at which the value of the registered mesh coordinate, and the maximum risk degree is highest (operation S304).

With respect to the mesh of each layer formed on the selected mesh coordinate, the each-layer adjustment range calculator 25 calculates a risk-degree range adjustable by changing the layout (patterns) of the dummy metal (operation S305).

The optimizing processor 26 derives an optimum risk degree of each mesh in the adjustable range calculated by the each-layer adjustment range calculator 25 (operation S306), updates the data of the wire density and the wire circumference length so that each mesh has the thus-derived optimum risk degree and updates the risk degree on the basis of the thus-updated wire density and wire circumference length (operation S307). Thereafter, the selected mesh coordinate is removed from the corrected candidate mesh data (operation S308), and then the processing returns to the operation S303.

When the corrected candidate mesh data is under the state that no mesh coordinate is registered in the corrected candidate mesh data (operation S303, No), it is determined whether the processing may be finished or not (operation S309). This is because when the temporarily registered corrected candidate mesh data are updated by optimizing the risk degree, the updated new risk degree may exceed the threshold value. Specifically, in the finishing determining process, when all the maximum risk degrees are less than the threshold value or when the repetitive frequency of the processing from the extraction of the maximum risk degree till the optimization of the risk degree reaches a predetermined one, it is determined that the processing may be finished.

When the processing is not finished (operation S309, No), the processing returns to the operation S301. When the processing is finished (operation S309, Yes), the arrangement of the dummy metal is calculated in conformity with the risk degree updated by the dummy metal arranging unit 27 (operation S310), and then the processing is finished.

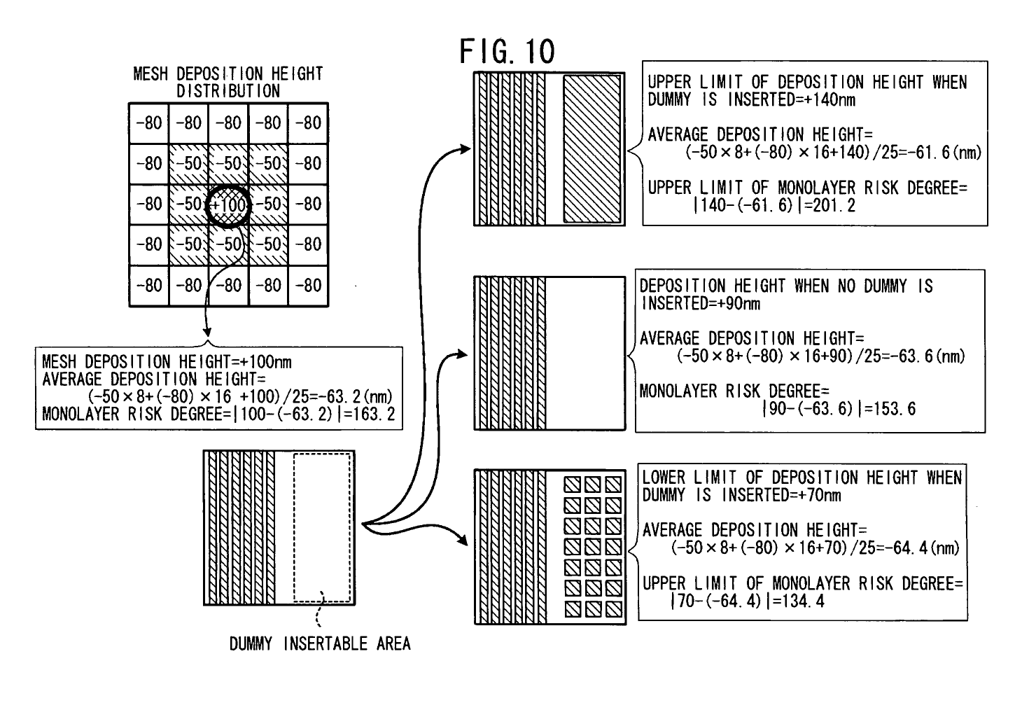

Next, the calculation of the risk degree and the adjustment range will be described with reference to FIG. 10. The estimation apparatus 20 sections an LSI chip in a mesh form, and a mesh having a sharp plating (deposition) height difference from surrounding meshes around the mesh is set as a risk place. Various manners such as the difference from the average value of several surrounding meshes, the deviation, etc. may be applied.

For example, the absolute value of the difference between the deposition (plating) height of a target mesh and the average deposition (plating) height of the surrounding meshes is set as the value of the risk degree (estimation value), and “risk degree error” is output when the estimation value is equal to 200 nm or more. In this case, when the deposition height of a target mesh (center mesh) is equal to +100 nm from a reference plane, the deposition height of the adjacent meshes is equal to −50 nm and the deposition height of the surrounding meshes around the adjacent meshes is equal to −80 nm as illustrated in FIG. 10, the simple average value of the deposition height is equal to (−50*8+−80*16+100)/25=−63.2(nm), and the mono-layer risk degree of the target mesh is equal to 100−(−63.2)=163.2.

Furthermore, when the averaging is executed while the first surrounding meshes (the meshes which are just adjacent to the target mesh) are weighted by (×1.0) and the second surrounding meshes (the meshes which surround the target mesh through the first surrounding meshes) are weighted by (×0.5), the average value of the deposition height is calculated by (−50*8+(−80)*16*0.5+100)/(1+8+16*0.5)=−55.3, and thus the monolayer risk degree of the target mesh is equal to 100−(−55.2)=155.3.

Furthermore, when an index of a lamination layer is derived on the basis of the difference in numerical value between the upper and lower layers, the difference between the monolayer risk degree of the target mesh and the monolayer risk degree of the lower layer may be calculated. For example, when the monolayer risk degree of the target mesh is equal to 163.2 and the monolayer risk degree of the lower layer is equal to −70, the risk degree of the lamination layer is equal to 163.2−(−70)=233.2 (nm).

The adjustment range of the risk degree of the center mesh will be considered by applying to a case where the risk degree of the mesh at the center is calculated from the simple average value, that is, the monolayer risk degree of the center mesh is equal to 163.2 as described.

When the dummy metal is arranged in the mesh, a dummy metal insertable area is determined every mesh by an original circuit layout, and the changeable wire density is restricted by insertion of a dummy. Furthermore, in the case of the same wire density, the deposition height is increased as the size of the dummy metal is reduced and the number of the dummy metal pieces is increased. On the other hand, the deposition height is reduced as the size is increased and the number is reduced.

In the example of FIG. 10, the upper limit of the deposition height is equal to +140 nm by changing the layout (patterns) of the dummy inserted into the dummy insertable area. Accordingly, the average deposition height is equal to (−50*8+−80*16+140)/25=−61.6(nm), and the upper limit of the monolayer risk degree of the target mesh is equal to 140−(−61.6)=201.2.

The deposition height when no dummy is inserted is equal to +90 nm. Accordingly, the average deposition height is equal to (−50*8+−80*16+90)/25=−63.6(nm), and thus the monolayer risk degree of the target mesh is equal to 90−(−63.6)=153.6.

The lower limit of the deposition height when the layout (patterns) of the dummy inserted into the dummy insertable area is equal to +70 nm. Accordingly, the average deposition height is equal to (−50*8+−80*16+70)/25=−64.4(nm), and the lower limit of the monolayer risk degree of the target mesh is equal to 70−(−61.6)=134.4.

Next, the optimization of the risk degree will be further described. When the risk degree is optimized, specifically, the difference in risk degree between layers, that is, the sum of squares of the risk degrees of the lamination layer may be minimized. Furthermore, the risk degree in the monolayer may be considered, or any function may be used to weight the risk degree or the like.

With respect to the optimization itself, all the layers may be optimized at once by using a gradient method, a steepest descent method or the like, or the optimization may be performed every two layers.

As an example, when the uppermost plane is set to an n-th layer and the initial risk degree of an i-th layer is set to xᵢ⁽⁰⁾, the risk degree may be optimized by the calculation expression below:

$$[ f ( x ) = {( {x}_{n} - {x}_{n - 1} )}^{2} + {( {x}_{n - 1} - {x}_{n - 2} )}^{2} … {( {x}_{2} - {x}_{1} )}^{2} ]$$

$$f ( x ) = {( {x}_{n} - {x}_{n - 1} )}^{2} + {( {x}_{n - 1} - {x}_{n - 2} )}^{2} … {( {x}_{2} - {x}_{1} )}^{2}$$

$$( {x}^{( k + 1 )} = {x}^{( k )} - α [ \begin{matrix}\partial f ( {x}^{( k )} ) / \partial {x}_{1}^{( k )} \\ \partial f ( {x}^{( k )} ) / \partial {x}_{2}^{( k )} \\ ⋮ \\ \partial f ( {x}^{( k )} ) / \partial {x}_{n}^{( x )}\end{matrix} ] )$$

$${x}^{( k + 1 )} = {x}^{( k )} - α [ \begin{matrix}\partial f ( {x}^{( k )} ) / \partial {x}_{1}^{( k )} \\ \partial f ( {x}^{( k )} ) / \partial {x}_{2}^{( k )} \\ ⋮ \\ \partial f ( {x}^{( k )} ) / \partial {x}_{n}^{( x )}\end{matrix} ]$$

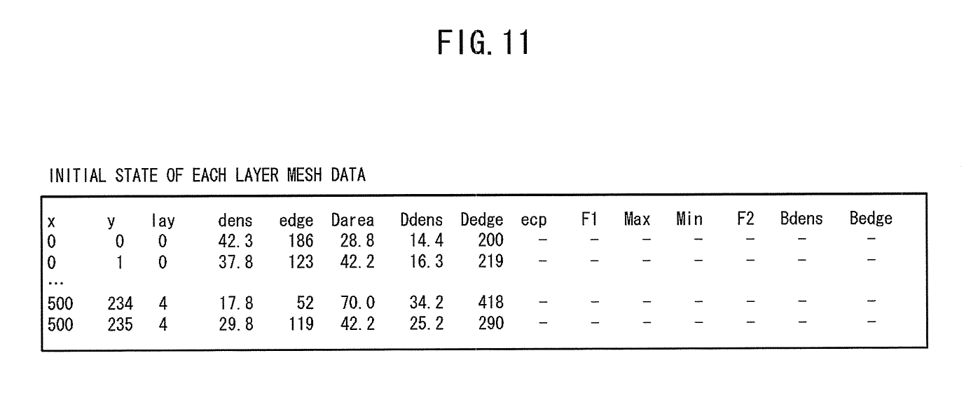

FIG. 11 is a diagram illustrating a specific example of each-layer mesh data as input/output data of the estimation apparatus 20. The data illustrated in FIG. 11 include items of the mesh coordinate x, the mesh coordinate y, the layer (Lay), the copper density dens, the wire circumference length edge (nm), the dummy insertable area Darea, the dummy-based copper density Ddens (%), the dummy-based wire circumference length Dedge (nm), the deposition (plating) height ecp (nm), the monolayer risk degree F1, the monolayer risk degree upper limit Max, the monolayer risk degree lower limit Min, the optimum monolayer risk degree F2, and the dummy copper density Bdens and the dummy wire circumference length Bedge at the optimum monolayer risk degree F2.

The items which have been already input in FIG. 11 are data which are obtained from the data created by the layout design device 11, and values have been input in only the mesh coordinate x, the mesh coordinate y, the layer (Lay), the copper density dens, the wire circumference length edge (nm), the dummy insertable area Darea, the dummy copper density Ddens and the dummy wire circumference length Dedge (nm).

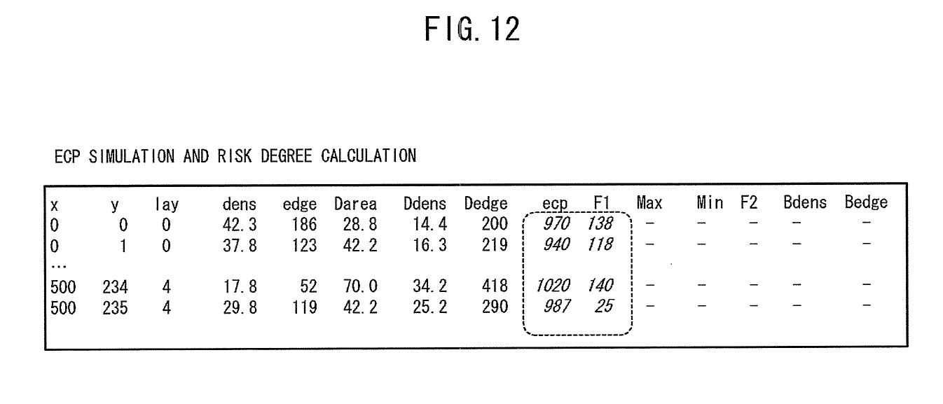

The ECP calculator 22 and the risk degree estimator 23 executes ECP simulation and risk degree check by using the data illustrated in FIG. 11, and fills the values of the deposition height ecp (nm) and the monolayer risk degree F1 into these items (FIG. 12).

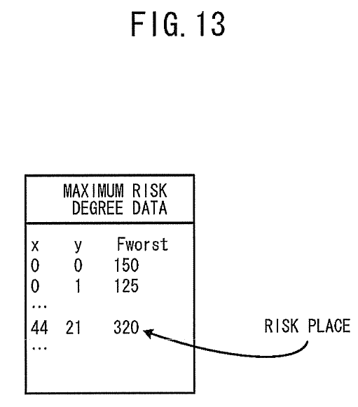

The each-mesh maximum risk degree extractor 24 extracts the maximum risk degree with respect to each mesh coordinate, and creates maximum risk degree data illustrated in FIG. 13. The maximum risk degree data illustrated in FIG. 13 include the items of the mesh coordinates x, y and the maximum risk degree Fworst. In FIG. 12, the maximum risk degree is the maximum value of the risk degree at the same mesh coordinate, and it is the maximum value in the monolayer risk degree F1 and the lamination layer risk degree corresponding to the difference in monolayer risk degree F1 between the adjacent layers in the up-and-down direction. In these maximum risk degree data, the mesh coordinate at which the maximum risk degree exceeds a predetermined threshold value is a risk place which is needed to be corrected. In FIG. 13, the maximum risk degree at (x,y)=(44, 27) exceeds the threshold value.

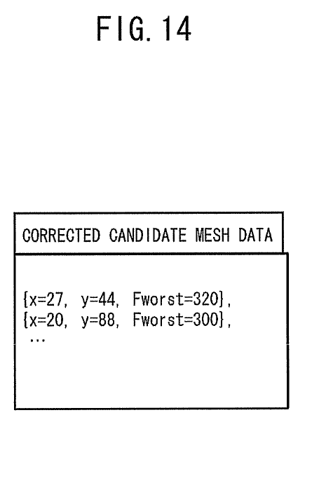

The corrected candidate mesh data are data for holding risk places as correction candidates. As illustrated in FIG. 14, mesh coordinates at which the maximum risk degree exceeds the threshold value are extracted from the maximum risk degree data, and then sorted in the order of the maximum risk degree.

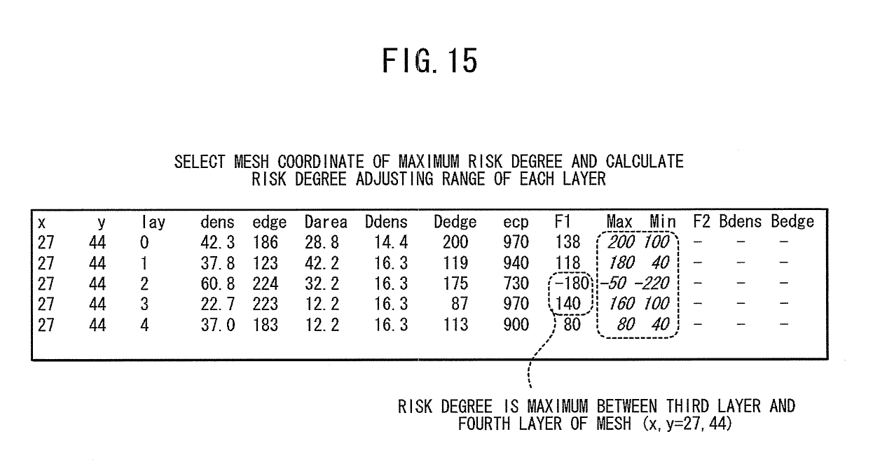

FIG. 15 illustrates data obtained by selecting the mesh coordinate providing the largest maximum risk degree, that is, the first mesh coordinate of the corrected candidate data and determining the risk degree adjustment range of each layer. Specifically, with respect to the data illustrated in FIG. 15, data are extracted from the each-layer mesh data for (x,y)=(27, 44) which is the head data illustrated in FIG. 14, and the monolayer risk degree upper limit Max and the monolayer risk degree lower limit Min of each layer are determined. In FIG. 15, the lamination layer risk degree between layer=2 and layer=3 is equal to 320, and thus it is the maximum risk degree.

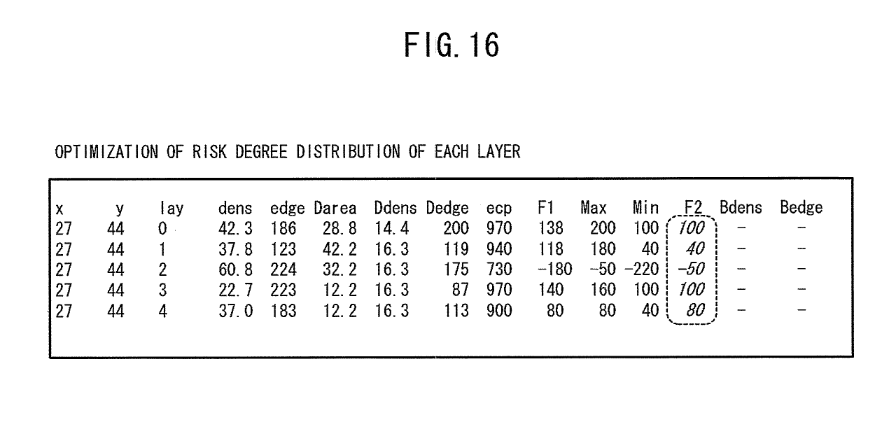

FIG. 16 illustrates data obtained by optimizing the distribution of the risk degree between the monolayer risk degree upper limit Max and the monolayer risk degree lower limit Min and determining the optimum monolayer risk degree F2 of each layer.

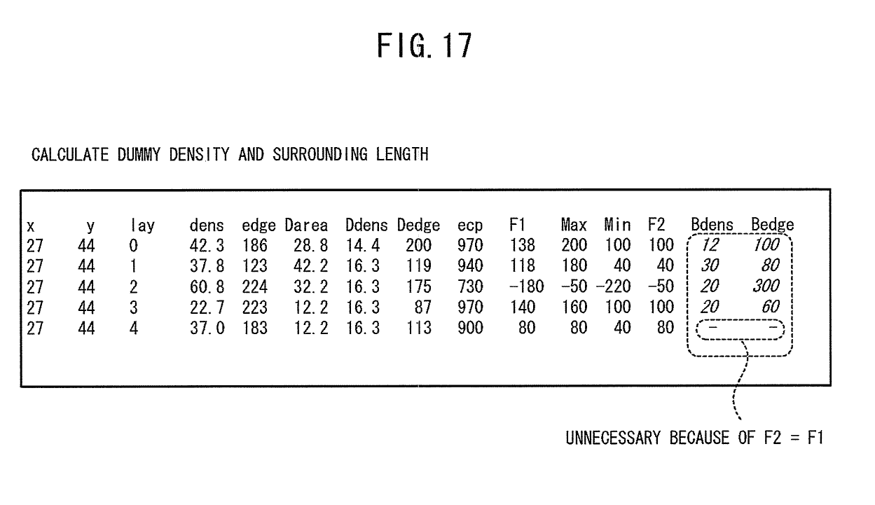

FIG. 17 illustrates a state that the dummy copper density Bdens and the dummy wire circumference length Bedge at the optimum monolayer risk degree F2 are determined from the optimum monolayer risk degree F2 of each layer.

Here, with respect to layer=4, the monolayer risk degree F1 is equal to the optimum monolayer risk degree F2, and thus it is unnecessary to determine anew the dummy copper density Bdens and the dummy wire circumference length Bedge.

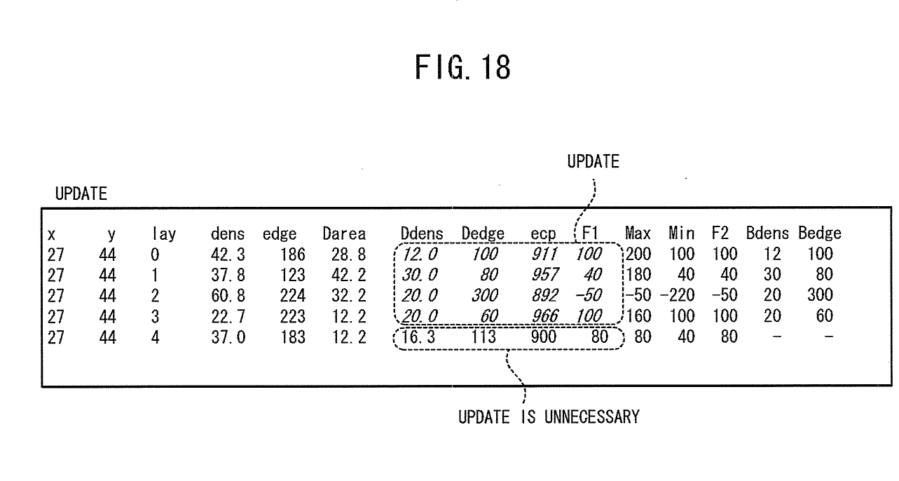

FIG. 18 is a diagram illustrating a state that the dummy-based copper density Ddens (%), the dummy-based wire circumference length Dedge (nm), the deposition height ecp (nm) and the monolayer risk degree F1 are updated from the dummy copper density Bdens and the dummy wire circumference length Bedge at the optimum monolayer risk degree F2. Here, with respect to layer=4, the monolayer risk degree F1 and the optimum monolayer risk degree F2 are equal, and the dummy copper density Bdens and the dummy wire circumference length Bedge are not determined. Therefore, these data are not needed to be updated.

As described above, in the LSI manufacturing system illustrated in the above embodiment, the estimation apparatus 20 subjects the circuit layout to mesh division, and simulates the deposition (plating) height of each mesh and determines the risk degree on the basis of the variation of the ECP deposition (plating) height. Furthermore, it optimizes the distribution of the risk degree in the height direction with respect to the meshes of the respective layers formed at the same mesh coordinate.

The ECP simulation (or the index of ECP) is determined in a shorter period of time as compared with the CMP simulation. Therefore, the CMP result may be predicted and estimated in a short period of time, and thus the layout correction speed may be increased, so that the yield may be enhanced in a short period of time.

Specifically, it is considered that the arrangement of the dummy metal is likewise changed by using the CMP simulation. In the case of ECP, the effect of the change of one mesh is closed in the mesh. However, in the case of CMP, the change of one mesh affects the overall chip, and thus the whole surface of the chip has to be simulated every time. Accordingly, assuming that the dummy is changed ten times in an area of 10% of the chip, it is roughly estimated that a calculation time of 8 hours× several thousands times or more is needed.

Particularly, the optimization is executed in consideration of all the layers in the height direction. Therefore, the layout correction speed may be more increased as compared with the case where the correction is executed in consideration of the horizontal direction of the same layer or only the risk degrees of layers adjacent to each other in the up-and-down direction.

The estimation apparatus may be constructed to provide an estimation program to a computer (CPU) of an LSI manufacturing system.

The estimation program may be stored in ROM of a computer, or stored in a “portable physical medium” such as a computer-readable flexible disk (FD), CD-ROM, a magneto-optical disk or the like, or in “another computer (or sever)” or the like connected to the computer through a public line, the Internet, LAN, WAN or the like so that the computer reads out and executes the program.

According to this embodiment, the estimation of the polishing process is executed in consideration of the lamination layer by using a deposition (plating) process simulation whose processing time is short. Therefore, there may be obtained the estimation apparatus, the estimation method and the storage medium having the estimation program stored therein with which the result of the polishing process may be estimated in a short period of time and thus the layout correction time may be increased, so that the yield may be enhanced in a short period of time.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An estimation apparatus for estimating a formation of a plurality of wiring layers for an integrated circuit to be manufactured by laminating the wiring layers each formed through a deposition process of a wiring material on a substrate and subsequently polishing the deposited wiring material, the apparatus comprising:
a deposition estimator configured to estimate distribution of a deposition height of the wiring material for each of the wiring layers;
a polishing estimator configured to estimate distribution of a height of the wiring material to be remained after polishing for each of the wiring layers on the basis of the estimated distribution of the deposition height of the wiring material of each of the wiring layers and the estimated distribution of the height of the wiring material to be remained after polishing for any underlying wiring layer;
an adjuster configured to adjust the pattern of at least one of the wiring layers without affecting the electrical function of the at least one of the wiring layers; and
an optimizer configured to optimize distribution of the height of the wiring material for each of the wiring layers within an acceptable range by controlling the adjuster to generate various combinations of adjusted patterns of the wiring layers and by controlling the deposition estimator and the polishing estimator to perform estimation of distribution of deposition height of the wiring material and distribution of the wiring material to be remained after polishing for each of the wiring layers, respectively, for each of the combinations of the adjusted patterns.

2. The estimation apparatus according to claim 1, further comprising a maximum estimation value extractor configured to create maximum estimation value data obtained by extracting a maximum estimation value representing highest necessity of improvement from the estimation values of the patterns to be laminated at each wiring layers on the deposition plane, wherein the adjuster calculates an acceptable range with respect to the various combination of the adjusted patterns to be laminated at a position where the maximum estimation value exceeds a threshold value.

3. The estimation apparatus according to claim 1, wherein the deposition estimator determines a prediction value of the deposition height after execution of the deposition process from a wire density and a wire circumference length in the patterns.

4. The estimation apparatus according to claim 1, wherein the adjuster calculates an acceptable range in a range which is changeable by insertion of dummy metal.

5. The estimation apparatus according to claim 1, wherein the deposition estimator further calculates a lamination-layer estimation value in consideration of lamination of layers by using the deposition height of the wiring material of a pattern as an estimation target and the deposition height of the wiring materials to be laminated at least one of above and below the pattern concerned.

6. A method for estimating a formation of a plurality of wiring layers for an integrated circuit to be manufactured by laminating the wiring layers each formed through a deposition process of a wiring material on a substrate and subsequently polishing the deposited wiring material, the method comprising:
estimating distribution of a deposition height of the wiring material for each of the wiring layers;
estimating distribution of a height of the wiring material to be remained after polishing for each of the wiring layers on the basis of the estimated distribution of the deposition height of the wiring material of each of the wiring layers and the estimated distribution of the height of the wiring material to be remained after polishing for any underlying wiring layer;
adjusting the pattern of at least one of the wiring layers without affecting the electrical function of the at least one of the wiring layers; and
optimizing distribution of the height of the wiring material for each of the wiring layers within an acceptable range by repeating the operation of estimating distribution of a deposition height of the wiring material and the operation of estimating distribution of a height of the wiring material to be remained after polishing, for various patterns of the wiring layer generated by repeating the operation of adjusting the patterns of at least one of the wiring layers.

7. A storage medium storing a estimation program allowing a computer to execute an estimation for estimating a formation of a plurality of wiring layers for an integrated circuit to be manufactured by laminating the wiring layers each formed through a deposition process of a wiring material on a substrate and subsequently polishing the deposited wiring material, the program allowing the computer to execute an operation, the operation comprising:
estimating distribution of a deposition height of the wiring material for each of the wiring layers;
estimating distribution of a height of the wiring material to be remained after polishing for each of the wiring layers on the basis of the estimated distribution of the deposition height of the wiring material of each of the wiring layers and the estimated distribution of the height of the wiring material to be remained after polishing for any underlying wiring layer;
adjusting the pattern of at least one of the wiring layers without affecting the electrical function of the at least one of the wiring layers; and
optimizing distribution of the height of the wiring material for each of the wiring layers within an acceptable range by repeating the operation of estimating distribution of a deposition height of the wiring material and the operation of estimating distribution of a height of the wiring material to be remained after polishing, for various patterns of the wiring layer generated by repeating the operation of adjusting the patterns of at least one of the wiring layers.
